(19) United States
(12) Patent Application Publication
(10) Pub. No.: US 2021/0384823 A1
(43) Pub. Date: Dec. 9, 2021

(54) POWER GENERATION SYSTEM AND METHOD OF OPERATING THE SAME

(71) Applicant: General Electric Company, Schenectady, NY (US)

(72) Inventor: Ravisekhar Nadimpalli Raju, Clifton Park, NY (US)

(21) Appl. No.: 17/287,785

(22) PCT Filed: Oct. 23, 2018
(86) PCT No.: PCT/US2018/057178

§ 371 Date: Apr. 22, 2021

(51) Int. Cl. H02M 3/155

(52) U.S. Cl. CPC H02M 3/155; H02J 7/35

(57) ABSTRACT

A power generation system includes a first power source, a second power source, an inverter, a DC-DC boost converter, and a control system. The control system includes a switching contactor coupled to the first power source, the second power source, the inverter, and the DC-DC boost converter. The control system further includes a controller operatively coupled to the switching contactor. The controller is configured to selectively connect one power source of the first power source and the second power source having a lower output voltage level among the first power source and the second power source to the inverter via the DC-DC boost converter. The controller is further configured to selectively connect other power source of the first power source and the second power source directly to the inverter.

### TECHNICAL FIELD

Embodiments of the present specification generally relate to a power generation system and, in particular to a power generation system having power sources utilizing a common power converter.

### BACKGROUND

Renewable energy based power generation sources, for example, photovoltaic (PV) power sources are becoming an important portion of the electricity generation mix. In a traditional power generation system, such PV power sources are generally augmented by via energy storage devices such as batteries to store the energy generated by the PV power sources and releasing the stored energy when required. Both the PV power sources and the energy storage devices are direct current (DC) sources. Typically, the power generated by these sources is required to be converted to an AC power via use of an inverter, for example, a three-phase inverter.

Traditionally, in order to account for any mismatch between output voltages of the PV power source and the energy storage device, two DC-DC power converter sections are required to connect the PV power source and the energy storage device to an inverter. By way of example, in one traditional approach, a DC-DC boost converter is coupled to each of the PV power source and the energy storage device. These DC-DC boost converters are coupled to an input of the inverter. The DC-DC boost converters are configured to raise output voltages of the PV power source and the energy storage device a DC bus voltage that is suitable for the inverter.

Alternatively, in another traditional approach, the PV power source is directly connected to the inverter, while the energy storage device is interfaced through a buck-boost DC-DC converter. The buck-boost DC-DC converter typically includes two DC-DC power converter stages. The buck-boost DC-DC converter allows an output voltage of the energy storage device to be above or below an output voltage of the PV power source.

Disadvantageously, both these traditional approaches require two stages of DC-DC conversion. Use of two such DC-DC power conversion stages results in increased cost of the traditional power generation system and reduced efficiency of the power conversion. Consequently, a levelized cost of energy (LCOE) generated by such traditional power generation system also increases.

### BRIEF DESCRIPTION

In accordance with one embodiment of the present specification, a power generation system is presented. The power generation system includes a first power source, a second power source, an inverter, a direct current (DC)-DC boost converter, and a control system coupled to the first power source, the second power source, the inverter, and the DC-DC boost converter. The control system includes a switching contactor coupled to the first power source, the second power source, the inverter, and the DC-DC boost converter. The control system further includes a controller operatively coupled to the switching contactor. The controller is configured to control switching of the switching contactor to selectively connect one power source of the first power source and the second power source having a lower output voltage level among the first power source and the second power source to the inverter via the DC-DC boost converter. The controller is further configured to control switching of the switching contactor to selectively connect other power source of the first power source and the second power source directly to the inverter.

In accordance with another embodiment of the present specification, a control system for a power generation system is presented. The power generation system includes a first power source, a second power source, an inverter, and a DC-DC boost converter. The control system includes a switching contactor coupled between the first power source, the second power source, the inverter, and the DC-DC boost converter. The control system further includes a controller operatively coupled to the switching contactor. The controller is configured to control switching of the switching contactor to selectively connect one power source of the first power source and the second power source having a lower output voltage level among the first power source and the second power source to the inverter via the DC-DC boost converter. Further, the controller is configured to control switching of the switching contactor to selectively connect other power source of the first power source and the second power source directly to the inverter.

In accordance with yet another embodiment of the present specification, a method for operating a power generation system is presented. The power generation system includes a first power source, a second power source, an inverter, and a DC-DC boost converter. The method includes determining output voltage levels of the first power source and the second power source based on electrical signals received from one or more sensors coupled to the first power source and the second power source. The method further includes selectively connecting a power source having a lower output voltage level among the first power source and the second power source to the inverter via the DC-DC boost converter by controlling switching of a switching contactor and connecting other power source of the first power source and the second power source directly to the inverter by controlling switching of the switching contactor.

### DRAWINGS

These and other features, aspects, and advantages of the present specification will become better understood when the following detailed description is read with reference to the accompanying drawings in which like characters represent like parts throughout the drawings, wherein:

FIG. 1 is a schematic diagram of a power generation system, in accordance with one embodiment of the present specification;

FIG. 2 is a schematic diagram of the power generation system of FIG. 1 when a first power source is connected to an inverter via a DC-DC boost converter, in accordance with one embodiment of the present specification;

FIG. 3 is a schematic diagram of the power generation system of FIG. 1 when a second power source is connected to an inverter via a DC-DC boost converter, in accordance with one embodiment of the present specification;

FIG. 4 is a schematic diagram of a power generation system, in accordance with another embodiment of the present specification;

FIG. 5 is a flow diagram of a method for operating the power generation systems of FIGS. 1 and 4, in accordance with one embodiment of the present specification;

FIG. 6 is a flow diagram of a detailed method for operating the power generation systems of FIGS. 1 and 4, in accordance with one embodiment of the present specification;

FIG. 7 is a flow diagram of a detailed method for operating the power generation system of FIG. 1, in accordance with another embodiment of the present specification; and

FIG. 8 is a flow diagram of a detailed method for operating the power generation system of FIG. 1, in accordance with yet another embodiment of the present specification.

### DETAILED DESCRIPTION

In an effort to provide a concise description of these embodiments, all features of an actual implementation may not be described in the specification. It should be appreciated that in the development of any such actual implementation, as in any engineering or design project, numerous implementation-specific decisions may be made to achieve the developer's specific goals such as compliance with system-related and business-related constraints.

Unless defined otherwise, technical and scientific terms used herein have the same meaning as is commonly understood by one of ordinary skill in the art to which this specification belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

As will be described in detail hereinafter, various embodiments of a power generation system are presented. The power generation system includes a first power source, a second power source, an inverter, a direct current (DC)-DC boost converter, and a control system coupled to the first power source, the second power source, the inverter, and the DC-DC boost converter. The control system includes a switching contactor coupled to the first power source, the second power source, the inverter, and the DC-DC boost converter. The control system further includes a controller operatively coupled to the switching contactor. The controller is configured to control switching of the switching contactor to selectively connect one power source of the first power source and the second power source having a lower output voltage level among the first power source and the second power source to the inverter via the DC-DC boost converter. The controller is further configured to control switching of the switching contactor to selectively connect other power source of the first power source and the second power source directly to the inverter.

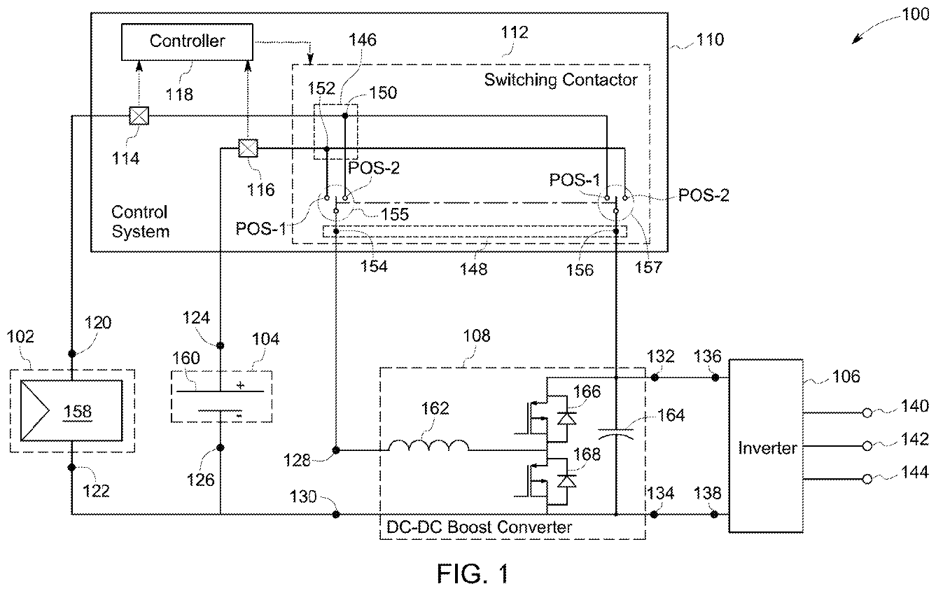

Referring now to FIG. 1, a schematic diagram of a power generation system 100 is depicted in accordance with one embodiment of the present specification. The power generation system 100 includes a first power source 102, a second power source 104, an inverter 106, a direct current (DC)-DC boost converter 108, and a control system 110. In some embodiments, the control system 110 may include one or more of a switching contactor 112, one or more sensors 114, 116, and a controller 118.

Further, in FIG. 1, reference numerals 120 and 122 represent output terminals of the first power source 102, and reference numerals 124 and 126 represent output terminals of the second power source 104. Furthermore, reference numerals 128 and 130 represent input terminals of the DC-DC boost converter 108, and reference numerals 132 and 134 represent output terminals of the DC-DC boost converter 108. Moreover, reference numerals 136 and 138 represent input terminals of the inverter 106 and reference numerals 140, 142, and 144 represent output terminals of the inverter 106.

The first power source 102 may be representative of any power source that is capable of supplying DC voltage at its output terminals 120, 122. In some embodiments, the first power source 102 may include a photovoltaic (PV) power source 158. The PV power source 158 may include one or more PV modules (not shown). The PV modules may be arranged in a series connection, parallel connection, or a series-parallel connection. Each of the PV modules may include a plurality of PV panels arranged in a series connection, parallel connection, or a series-parallel connection. The PV power source 158 having such PV modules may generate a DC power (i.e., DC voltage and DC current) depending on solar insolation, weather conditions, and/or time of the day. In some other embodiments, the first power source 102 may include fuel-cell based power source. In certain embodiments, the first power source 102 may include an AC power source capable of generating an AC power along with a rectifier (i.e., AC to DC power converter) to supply the DC voltage at the output terminals 120, 122. Non-limiting examples of such AC power source may include a generator, wind turbine, a hydro turbine, or combinations thereof.

In some embodiments, the second power source 104 may include an energy storage device 160. The energy storage device 160 may include one or more capacitors, one or more batteries, one or more superconducting magnetic energy storage devices, or combinations thereof. In the non-limiting embodiment of FIG. 1, the energy storage device 160 is represented by a battery.

The DC-DC boost converter 108 may include a suitable arrangement of one or more inductors, one or more capacitors, and one or more switches. In the embodiment of FIG. 1, the DC-DC boost converter 108 includes an inductor 162, a capacitor 164 and switches such as, metal-oxide-semiconductor field-effect transistors (MOSFETs) 166, 168. In particular, the inductor 162, the capacitor 164, and switches 166, 168 are arranged such that a drain terminal of the switch 166 is connected to the input terminal 136 of the inverter 106, a source terminal of the switch 166 is connected to a drain terminal of the switch 168, and a source terminal of the switch 168 is connected to the input terminal 138 of the inverter 106. Further, the inductor 162 is connected between the input terminal 128 and the source terminal of the switch 166. Furthermore, the capacitor 164 is connected across the output terminals 132, 134 of the DC-DC boost converter 108. Although the DC-DC boost converter 108 is shown to include a particular arrangement of the inductor 162, the capacitor 164 and the switches 166, 168, as depicted in FIG. 1, the scope of the present specification is not restricted with respect to an internal configuration of the DC-DC boost converter 108. Any suitable arrangement of electronic component may be used to effect DC-DC boost power conversion.

The inverter 106 is connected to the DC-DC boost converter 108. In particular, as depicted in FIG. 1, the input terminals 136, 138 of the inverter 106 are respectively connected to the output terminals 132, 134 of the DC-DC boost converter 108. As it is apparent to a person having ordinary skills in the art, the inverter 106 may include suitable arrangement of a plurality of switches (not shown) and a gate drive circuit to convert DC power available at the input terminals 136, 138 into an AC power. The scope of the present specification is not restricted with respect to a configuration of the inverter 106. By way of example, the inverter 106 of FIG. 1 is a three-phase inverter which converts the DC power available at the input terminals 136, 138 into a three-phase AC power which is available at the output terminals 140, 142, and 144 of the inverter 106.

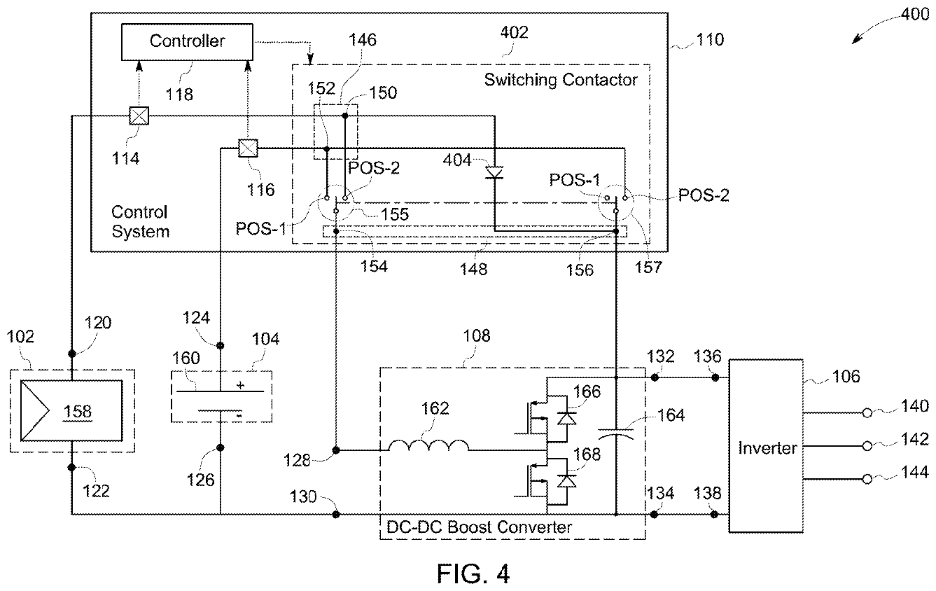

The control system 110 may comprise the switching contactor 112 as well as one or more control units for controlling the switching contactor 112, the first power source 102, the second power source 104, the inverter 106, and the DC-DC boost converter 108. In particular, the switching contactor 112 of the control system 110 is coupled to the first power source 102, the second power source 104, the inverter 106, and the DC-DC boost converter 108. By way of a non-limiting example, the switching contactor 112 may be a double-pole-double-throw (DPDT) contactor. The switching contactor 112 has an input port 146 and an output port 148. The input port 146 includes two input terminals 150, 152, for example. The output port 148 includes two output terminals 154, 156, for example. The switching contactor 112 shown in FIG. 1 also includes switching elements 155, 157 connected between the input port 146 and the output port 148. In some embodiments, the switching elements 155, 157 are semiconductor switches. Non-limiting examples of such semiconductor switches may include transistors, gate commutated thyristors, field effect transistors, insulated gate bipolar transistors, gate turn-off thyristors, static induction transistors, static induction thyristors, or combinations thereof. Moreover, materials used to form the semiconductor switch may include, but are not limited to, silicon (Si), germanium (Ge), silicon carbide (SiC), gallium nitride (GaN), gallium arsenide (GaAs) or combinations thereof. In some embodiments, the switching contactor 112 may include a plurality of switches (e.g., the switching elements 155, 157), a diode, or combinations thereof (see FIG. 4). Although the switching contactor 112 is shown to be the DPDT contactor in FIG. 1, any other type of contactor or combination of switching elements/switches may be used as the switching contactor 112 (see FIG. 4, for example), without limiting the scope of the present specification. The switching contactor 112 may be operated in one of two positions—POS-1 and POS-2, as indicated in FIG. 1.

In the circuit arrangement of FIG. 1, the input terminals 150 and 152 of the input port 146 are respectively connected to the output terminal 120 of the first power source 102 and the output terminal 124 of the second power source 104. Further, the output port 148 of the switching contactor 112 is coupled to the DC-DC boost converter 108 and the inverter 106. In particular, the output terminal 154 of the output port 148 is connected to the input terminal 128 of the DC-DC boost converter 108, and the output terminal 156 of the output port 148 is connected to the output terminal 132 of the DC-DC boost converter 108 and the input terminal 136 of the inverter 106.

Further, in some embodiments, the control system 110 may include the one or more sensors 114, 116 coupled to the first power source 102 and the second power source 104. The sensors 114, 116 may be electrically connected to the first power source 102 and the second power source 104, respectively, as shown in FIG. 1. Use of more than two sensors is also contemplated within the scope of the present specification. By way of example, the sensors 114, 116 may be current sensors, voltage sensors, or a combination thereof. In the description hereinafter, the sensors 114, 116 are described as voltage sensors where the sensors 114, 116 may be configured to generate electrical signals indicative of voltage at their respective point of connection in the power generation system 100. In particular, the sensors 114, 116 are configured to generate electrical signals indicative of output voltage levels of the first power source 102 and the second power source 104 across their output terminals. In some embodiments, the electrical signals are indicative on an open-circuit voltage levels of the first power source 102 and the second power source 104. In certain other embodiments, the control system 110 may, alternatively or additionally, include other type of sensors including, but not limited to, solar insolation sensor(s) (not shown), temperature sensor(s) (not shown).

Furthermore, the control system 110 includes the controller 118. The controller 118 may be operatively coupled to the sensors 114, 116 and the switching contactor 112. The controller 118 may include a specially programmed general-purpose computer, an electronic processor such as a microprocessor, a digital signal processor, and/or a microcontroller. In some embodiments, the controller 118 may include input/output ports, and a storage medium, such as an electronic memory. Various examples of the microprocessor include, but are not limited to, a reduced instruction set computing (RISC) architecture type microprocessor or a complex instruction set computing (CISC) architecture type microprocessor. Further, the microprocessor may be a single-core type or multi-core type. In some embodiments, the controller 118 may be implemented using hardware elements such as logic gates, electronic components, switches.

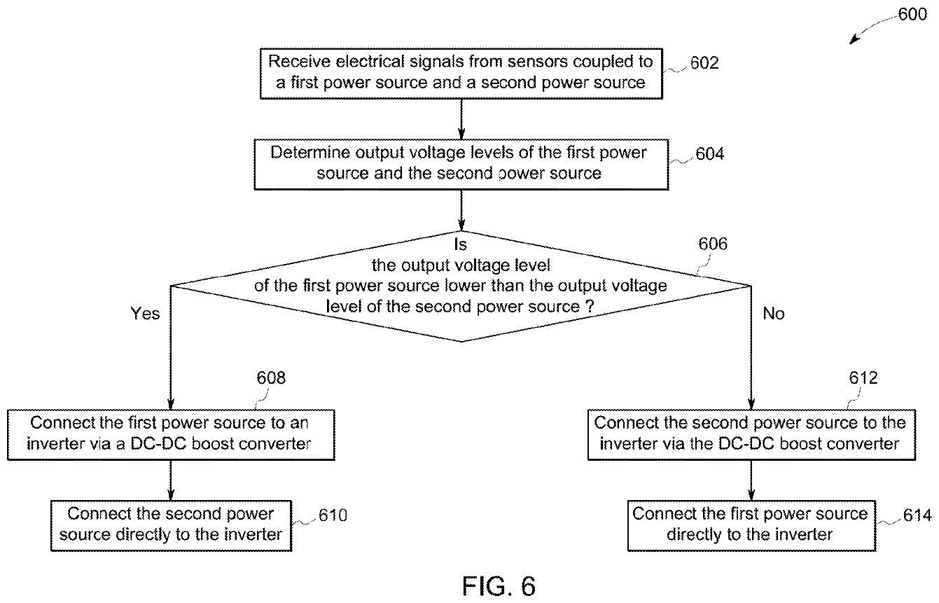

The controller 118 may be configured to control switching of the switching contactor 112. In some embodiments, the controller 118 may be configured to control the switching of the switching contactor 112 based on the electrical signal received from the sensors 114, 116, the solar insolation sensors, and/or the temperature sensors, for example. In particular, the controller 118 may be configured to selectively connect one power source of the first power source 102 and the second power source 104 which has a lower output voltage level among the first power source 102 and the second power source 104 to the inverter 106 via the DC-DC boost converter 108. Further, the controller 118 may be configured to selectively connect other power source of the first power source 102 and the second power source 104 directly to the inverter 106. In certain embodiments (see FIG. 6), the controller 118 is configured to selectively connect the one power source of the first power source 102 and the second power source 104 to the inverter 106 via the DC-DC boost converter 108 if a difference between the output voltage levels of the first power source 102 and the second power source 104 is greater than a predefined tolerance value.

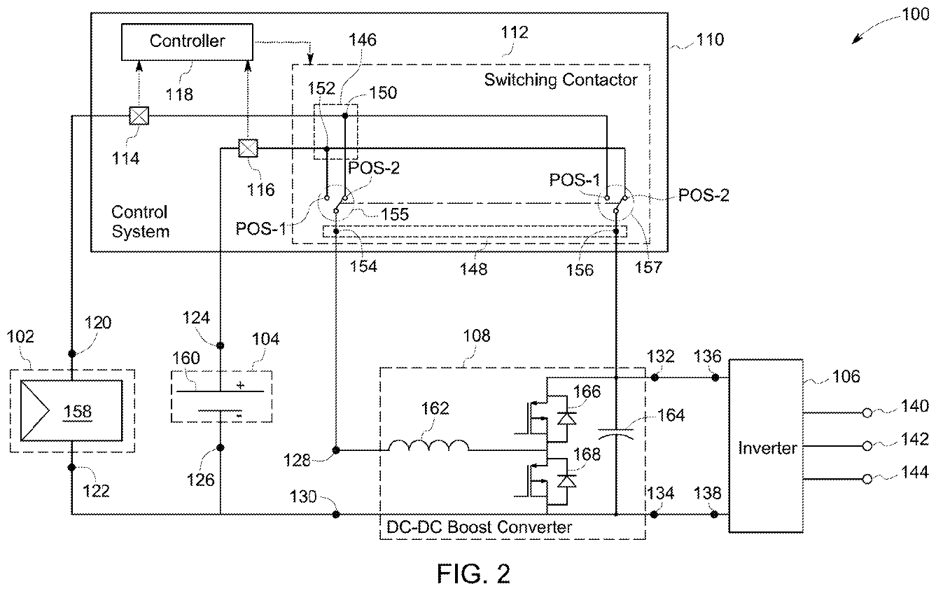

In some embodiments, based on the electrical signals received from the sensors 114, 116, if the controller 118 determines that a voltage level of the first power source 102 is lower than a voltage level of the second power source 104, the controller 118 may be configured to selectively connect the first power source 102 to the inverter 106 via the DC-DC boost converter 108, and connect the second power source 104 directly to the inverter 106 (see FIG. 2). In FIG. 2, a schematic diagram depicting a configuration of the power generation system 100 of FIG. 1 is presented when the first power source 102 is connected to the inverter 106 via the DC-DC boost converter 108, in accordance with one embodiment of the present specification. To establish such connections, the controller 118 may send control signal(s) to the switching contactor 112 to operate the switching contactor 112 in POS-2, as shown in FIG. 2. When the switching contactor 112 is operated in POS-2, the output terminal 120 of the first power source 102 is connected to the input terminal 128 of the DC-DC boost converter 108, and the output terminal 124 of the second power source 104 is connected to the input terminal 136 of the inverter 106.

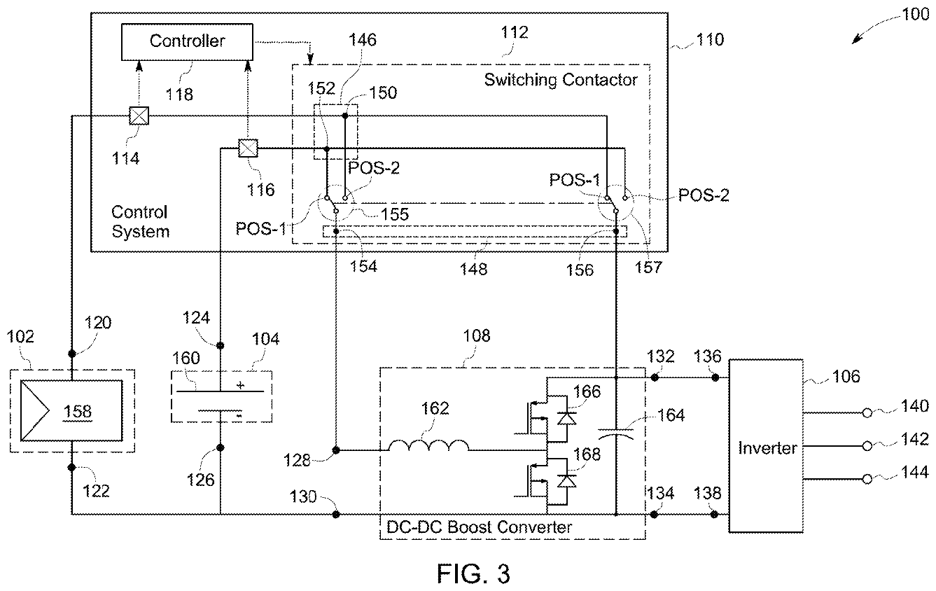

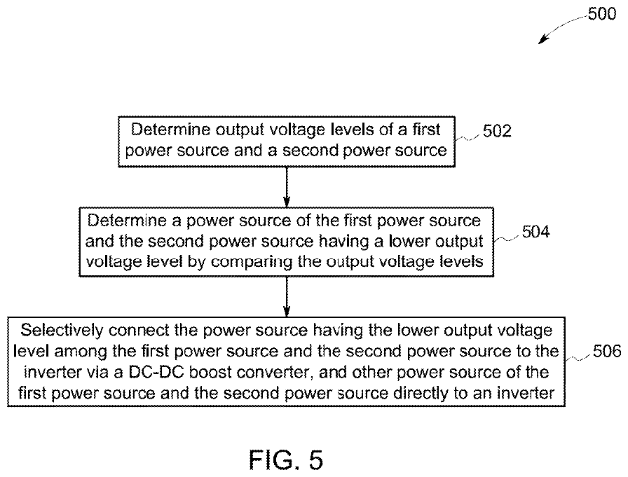

Turning again to FIG. 1, alternatively, if the controller 118 determines that the voltage level of the first power source 102 is greater than or equal to the voltage level of the second power source 104, the controller 118 may be configured to selectively connect the second power source 104 to the inverter 106 via the DC-DC boost converter 108 and connect the first power source 102 directly to the inverter 106 (see FIG. 3). In FIG. 3, a schematic diagram depicting a configuration of the power generation system 100 of FIG. 1 is presented when the second power source 104 is connected to the inverter 106 via the DC-DC boost converter 108, in accordance with one embodiment of the present specification. To establish such connections, the controller 118 may send control signal(s) to the switching contactor 112 to operate the switching contactor in POS-1, as shown in FIG. 3. When the switching contactor 112 is operated in POS-1, the output terminal 124 of the second power source 104 is connected to the input terminal 128 of the DC-DC boost converter 108, and the output terminal 120 of the first power source 102 is connected to the input terminal 136 of the inverter 106. Additional details of the operations performed by the controller 118 will be described in conjunction with FIGS. 5 and 6.

Moreover, in certain embodiments, in a situation when the voltage level of the first power source 102 is higher than the voltage level of the second power source 104, the energy storage device 160 of the second power source 104 may be charged using electrical power generated by the first power source via the DC-DC boost converter 108.

As will be appreciated, in the power generation system 100 of FIG. 1, the DC-DC boost converter 108 is advantageously shared between the first power source 102 and the second power source 104. In particular, the power source which has lower output voltage is connected to the inverter 106 via the DC-DC boost converter 108, whereas the other power source is connected directly to the inverter 106. Such a shared usage of power electronic units such as the DC-DC boost converter 108 reduces overall cost and size/footprint of the power electronic unit used in the power generation system 100. Also, due to the reduced cost of power electronic units, the LCOE for power generated by the power generation system 100 is also reduced in comparison to traditional power generation system utilizing two DC-DC power converter stages.

Referring now to FIG. 4, a schematic diagram of a power generation system 400 is presented, in accordance with another embodiment of the present specification. The power generation system 400 includes certain components that are similar to the components used in the power generation system 100 of FIG. 1, description of which is not repeated herein. The power generation system 400 includes a switching contactor 402 that is representative of one embodiment of the switching contactor 112 of FIG. 1. In comparison to the switching contactor 112 of FIG. 1, the switching contactor 402 includes a diode 404 and the input terminal 150 is not connected to the switching element 157. In particular, the diode 404 is connected between the input terminal 150 of the switching contactor 402 (or the output terminal of the first power source 102) and the output terminal 156 of the switching contactor 402 (or the input terminal 136) of the inverter 106.

During operation of the power generation system 400, when the voltage level of the first power source 102 is lower than the voltage level of the second power source 104, the controller 118 may be configured to operate the switching contactor 402 in a POS-2 so that the first power source 102 is connected to the inverter 106 via the DC-DC boost converter 108, and the second power source 104 is connected directly to the inverter 106. However, when the voltage level of the first power source 102 is greater than or equal to the voltage level of the second power source 104, the controller 118 may be configured to operate the switching contactor 402 in a POS-1 so that the second power source 104 is connected to the inverter 106 via the DC-DC boost converter 108. Moreover, due the presence of the diode 404, when the voltage level of the first power source 102 is greater than the voltage level of the second power source 104, the first power source 102 is automatically connected directly to the inverter 106.

Referring now to FIG. 5, a flow diagram 500 of a method for operating the power generation system 100, 400 of the power generation systems of FIG. 1 or FIG. 4 is presented, in accordance with one embodiment of the present specification. In some embodiments, the controller 118 aids in executing the method of FIG. 5.

At step 502, the controller 118 determines output voltage levels of the first power source 102 and the second power source 104. In some embodiments, the output voltage levels may represent open-circuit voltage levels corresponding to the first power source and the second power source. In some embodiments, the output voltage levels of the first power source 102 and the second power source 104 may be determined based on the electrical signals received from one or more sensors 114, 116 coupled to the first power source 102 and the second power source 104. One or more parameters of the electrical signals are indicative of the output voltage levels of the first power source 102 and the second power source 104. By way of example, amplitudes of the electrical signals received from the sensors 114, 116 may be proportional to the output voltage levels at the output terminal 120 of the first power source 102 and the output terminal 124 of the second power source 104, respectively. The controller 118 may determine the output voltage levels of the first power source 102 and the second power source 104 based on the amplitudes of the electrical signals received from the sensors 114, 116, respectively.

In certain embodiments, the output voltage levels may represent estimated output voltage levels under load corresponding to the first power source 102 and the second power source 104. In some embodiments, the output voltage level of the first power source 102 may be a function of solar irradiance (G), an output current (I) of the first power source 102, a temperature-related factor (vₜₕ), a series resistance (Rₛ), and/or a shunt resistance (Rₛₕ). By way of example, the output voltage level (V_{first}) of the first power source 102 may be represented using a following equation (1):

V_{first}=ƒ(G,I_{first},vₜₕ,Rₛ,Rₛₕ) Equation (1)

In some embodiments, the controller 118 may be configured to estimate the output voltage level (V_{first}) of the first power source 102 based on any known relationship between the solar irradiance (G), the output current (I) of the first power source 102, the temperature-related factor (vₜₕ), the series resistance (Rₛ), and/or the shunt resistance (Rₛₕ). One such relationship to estimate the output voltage level (V_{first}) may be represented by a following simplified equation (2):

V_{first}=V_{oc,first}−RₛI_{first} Equation (2)

where, V_{oc,first} is represents an open circuit voltage of the first power source 102.

Further, in some embodiments, the controller 118 may determine (i.e., estimate) the output voltage level of the second power source 104 based on an estimation of an internal resistance of the energy storage device 160 and/or electrical signals received from the temperature sensors connected to the energy storage device 160. The output voltage level of the second power source 104 may be a function of a state of charge (SOC) of the energy storage device 160, an output current (I_{second}) of the energy storage device 160, and/or the internal resistance (Rᵢₙₜₑᵣₙₐₗ) of the energy storage device 160. By way of example, the output voltage level (V_{second}) of the second power source 104 may be represented using a following equation (3):

V_{second}=ƒ(SOC,I_{second},Rᵢₙₜₑᵣₙₐₗ) Equation (3)

In some embodiments, the controller 118 may be configured to estimate the output voltage level (V_{second}) of the second power source 104 based on any known relationship between the state of charge (SOC) of the energy storage device 160, an output current (I_{second}) of the energy storage device 160, and/or the internal resistance (Rᵢₙₜₑᵣₙₐₗ) of the energy storage device 160. One such relationship to estimate the output voltage level (V_{second}) may be represented by a following simplified equation (4):

V_{second}=V_{oc,second}−RᵢₙₜₑᵣₙₐₗI_{second} Equation (4)

where, V_{oc,second} represents an open circuit voltage of the second power source 104.

Further, at step 504, the controller 118 may determine a power source of the first power source 102 and the second power source 104 having a lower output voltage level by comparing the output voltage levels of the first power source 102 with the second power source 104. Furthermore, at step 506, the controller 118 may selectively connect the power source having the lower output voltage level among the first power source 102 and the second power source 104 to the inverter 106 via the DC-DC boost converter 108 by controlling switching of the switching contactor 112, 402, and selectively connect other power source of the first power source 102 and the second power source 104 directly to the inverter 106 by controlling switching of the switching contactor 112, 402. Additional details of the method for operating the power generation system 100, 400 of the power generation systems of FIG. 1 or FIG. 4 will be described in conjunction with FIG. 6.

Turning now to FIG. 6, a flow diagram 600 of a detailed method for operating the power generation system of any of the power generation systems of FIGS. 1 and 4 is presented, in accordance with one embodiment of the present specification. At step 602, the controller 118 may receive electrical signals from the sensors 114, 116 coupled to the first power source 102 and the second power source 104. Further, at step 604, the controller 118 determines output voltage levels of the first power source 102 and the second power source 104 based on the electrical signals received from one or more sensors 114, 116 in a similar fashion as described in FIG. 5.

Moreover, at step 606, the controller 118 is configured to perform a check to determine whether the output voltage level of the first power source 102 is lower than the output voltage level of the second power source 104 by comparing the output voltage level of the first power source 102 with the output voltage level of the second power source 104. At step 606, if it is determined that the output voltage level of the first power source 102 is lower than the output voltage level of the second power source 104, the controller 118, at step 608, may be configured to connect the first power source 102 to the inverter 106 via the DC-DC boost converter 108. Moreover, at step 610, the controller 118 may be configured to connect the second power source 104 directly to inverter 106. In order to connect the first power source 102 and the second power source 104 as indicated in steps 606, 608, in one embodiment, the controller 118 may send control signal(s) to the switching contactor 112 such that the switching contactor 112, 402 operate in POS-2. When the switching contactor 112 or 402 is operated in POS-2, the output terminal 120 of the first power source 102 is connected to the input terminal 128 of the DC-DC boost converter 108, and the output terminal 124 of the second power source 104 is connected to the input terminal 136 of the inverter 106.

At step 606, if it is determined that the output voltage level of the first power source 102 is greater than or equal to the output voltage level of the second power source 104, the controller 118, at step 612, may be configured to connect the second power source 104 to the inverter 106 via the DC-DC boost converter 108. Moreover, at step 614, the controller 118 may be configured to connect the first power source 102 directly to inverter 106. In order to connect the first power source 102 and the second power source 104 as indicated in steps 612, 614, in one embodiment, the controller 118 may send control signal(s) to the switching contactor 112 such that the switching contactor 112, 402 operate in POS-1. In the configuration of the power generation system 100 of FIG. 1, when the switching contactor 112 is operated in POS-1, the output terminal 124 of the second power source 104 is connected to the input terminal 128 of the DC-DC boost converter 108, and the output terminal 120 of the first power source 102 is connected to the input terminal 136 of the inverter 106. In the configuration of the power generation system 400 of FIG. 4, when the switching contactor 402 is operated in POS-1, the output terminal 124 of the second power source 104 is connected to the input terminal 128 of the DC-DC boost converter 108, and the output terminal 120 is automatically connected to the input terminal 136 of the inverter 106 via the diode 406.

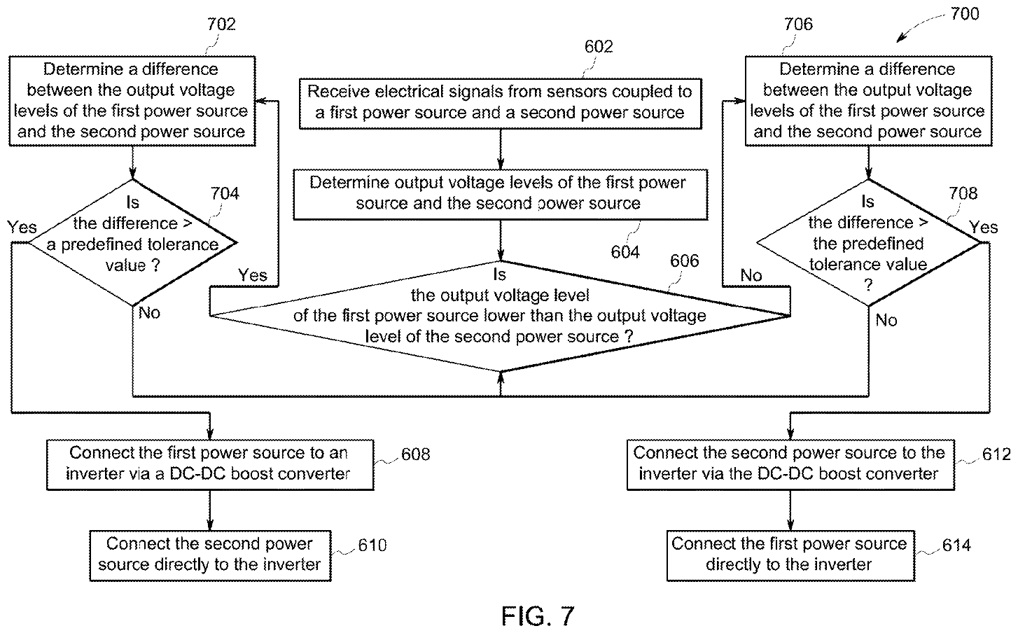

Referring now to FIG. 7, a flow diagram 700 of a detailed method for operating the power generation system 100 of FIG. 1 is presented, in accordance with another embodiment of the present specification. The method of FIG. 7, includes certain steps that are similar to the steps described in FIG. 6, description of which is not repeated herein. By way of example, the method of FIG. 7 includes steps 702, 704, 706, and 708 in addition to the steps 602, 604, 606, 608, 610 described in FIG. 6.

In certain embodiments, when the power generation system 100 is started, one of the first power source 102 or the second power source 104 is directly connected to the inverter 106 and the other power source is connected to the inverter 106 via the DC-DC boost converter 108. For example, at the start-up, in some embodiments, the switching contactor 112 may be operated in POS-1 so that the first power source 102 is directly connected to the inverter 106 and the second power source 104 is connected to the inverter 106 via the DC-DC boost converter 108. In another example, at the start-up, in some other embodiments, the switching contactor 112 may be operated in POS-2 so that the second power source 104 is directly connected to the inverter 106 and the first power source 102 is connected to the inverter 106 via the DC-DC boost converter 108.

During operation of the power generation system 100, at step 606, if it is determined that the output voltage level of the first power source 102 is lower than the output voltage level of the second power source 104, the controller 118, at step 702, may additionally determine a difference between the output voltage levels of the first power source 102 and the second power source 104. Moreover, at step 704, the controller 118 may be configured to perform a check to determine whether the difference (determined at step 702) between the output voltage levels of the first power source 102 and the second power source 104 is greater than a predefined tolerance value. At step 704, if it is determined that that the difference between the output voltage levels of the first power source 102 and the second power source 104 is greater than the predefined tolerance value, the controller 118 may proceed to execute step 608. However, at step 704, if it is determined that that the difference between the output voltage levels of the first power source 102 and the second power source 104 is smaller than the predefined tolerance value, the controller 118 may again execute step 606.

Further, at step 606, if it is determined that the output voltage level of the first power source 102 is greater than or equal to the output voltage level of the second power source 104, the controller 118, at step 706, may additionally determine the difference between the output voltage levels of the first power source 102 and the second power source 104. Moreover, at step 708, the controller 118 may be configured to perform a check to determine whether the difference between the output voltage levels of the first power source 102 and the second power source 104 is greater than the predefined tolerance value. At step 708, if it is determined that that the difference between the output voltage levels of the first power source 102 and the second power source 104 is greater than the predefined tolerance value, the controller 118 may proceed to execute step 612. However, at step 708, if it is determined that that the difference between the output voltage levels of the first power source 102 and the second power source 104 is smaller than the predefined tolerance value, the controller 118 may again execute step 606.

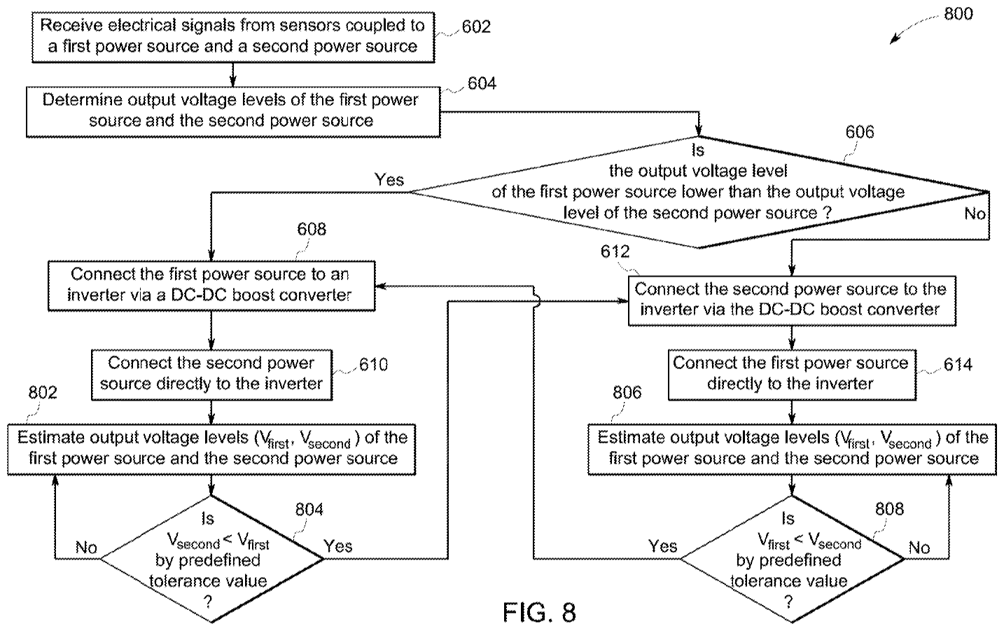

FIG. 8 is a flow diagram 800 of a detailed method for operating the power generation system 100 of FIG. 1, in accordance with yet another embodiment of the present specification. The method of FIG. 8, includes steps that are similar to the steps described in FIG. 6, description of which is not repeated herein. By way of example, the method of FIG. 8 includes steps 802, 804, 806, and 808 in addition to the steps 602, 604, 606, 608, 610 described in FIG. 6.

During operation of the power generation system 100, after step 610 is performed, the controller 118 may be configured to estimate output voltage levels (V_{first}, V_{second}) of the first power source 102 and the second power source 104 at step 802. The output voltage levels (V_{first}, V_{second}) may be estimated in a similar fashion as described in the method of FIG. 5. By way of example, the estimated output voltages (V_{first}, V_{second}) may be equal to open circuit voltage of the first power source 102 and the second power source 104. Further, at step 804, a check may be performed to determine whether the estimated output voltage level (V_{second}) of the second power source 104 is lower than the estimated output voltage level (V_{first}) of the first power source 102 by the predefined tolerance value. At step 804, if it is determined that the estimated output voltage level (V_{second}) of the second power source 104 is lower than the estimated output voltage level (V_{first}) of the first power source 102 by the predefined tolerance value, a control may return to the step 612. However, at step 804, if it is determined that the estimated output voltage level (V_{second}) of the second power source 104 is not lower than the estimated output voltage level (V_{first}) of the first power source 102 by the predefined tolerance value, a control may return to the step 802.

Further, after step 614 is performed, the controller 118 may be configured to estimate output voltages of the first power source 102 and the second power source 104 at step 806, for example, in a similar fashion as described in the method of FIG. 5. Further, at step 808, a check may be performed to determine whether the estimated output voltage level (V_{first}) of the first power source 102 is lower than the estimated output voltage level (V_{second}) of the second power source 104 by the predefined tolerance value. At step 808, if it is determined that the estimated output voltage level (V_{first}) of the first power source 102 is lower than the estimated output voltage level (V_{second}) of the second power source 104 by the predefined tolerance value, a control may return to the step 608. However, at step 808, if it is determined that the estimated output voltage level (V_{first}) of the first power source 102 is not lower than the estimated output voltage level (V_{second}) of the second power source 104 by the predefined tolerance value, a control may return to the step 806.

Any of the foregoing steps in any of FIGS. 5-8 may be suitably replaced, reordered, or removed depending on the needs of a particular application. Also, while certain steps are shown separately, some steps may also be performed simultaneously depending on the needs of a particular application.

Advantageously, in the power generation systems 100, 400 of FIGS. 1 and 4, the DC-DC boost converter 108 is shared between the first power source 102 and the second power source 104. In particular, the power source which has lower output voltage is connected to the inverter 106 via the DC-DC boost converter 108, whereas the other power source is connected directly to the inverter 106. Such a shared usage of power electronic units such as the DC-DC boost converter 108 reduces overall cost and size/footprint of the power electronic unit used in the power generation system 100. Also, due to the reduced cost of power electronic units, the LCOE for power generated by the power generation system 100 is reduced in comparison to a traditional power generation system utilizing two DC-DC power converter stages. Further, due to reduced number of power conversion stages, the power generation systems 100, 400 of FIGS. 1 and 4 are more efficient in comparison to the traditional power generation systems. Furthermore, due to the reduced number of power conversion stages, additional auxiliary systems, for example, cooling systems to control temperature of additional power converter stages may also be eliminated or reduced, resulting in further size and cost reduction. Moreover, due to reduced number of power conversion stages and cooling systems, power density and reliability of the power generation systems 100, 400 of FIGS. 1 and 4 is also enhanced.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

1. A power generation system, comprising:
a first power source;
a second power source;
an inverter;
a direct current (DC)-DC boost converter; and
a control system coupled to the first power source, the second power source, the inverter, and the DC-DC boost converter, wherein the control system comprises:
a switching contactor coupled to the first power source, the second power source, the inverter, and the DC-DC boost converter; and
a controller operatively coupled to the switching contactor and configured to control switching of the switching contactor to:
selectively connect one power source of the first power source and the second power source having a lower output voltage level among the first power source and the second power source to the inverter via the DC-DC boost converter; and
selectively connect other power source of the first power source and the second power source directly to the inverter.

2. The power generation system of claim 1, wherein the first power source comprises a photovoltaic (PV) power source.

3. The power generation system of claim 2, wherein the second power source comprises an energy storage device.

4. The power generation system of claim 3, wherein the energy storage device comprises one or more capacitors, one or more batteries, one or more superconducting magnetic energy storage devices, or combinations thereof.

5. The power generation system of claim 1, wherein the switching contactor comprises a double-pole-double-throw (DPDT) contactor.

6. The power generation system of claim 1, wherein the switching contactor comprises a plurality of switches, a diode, or combinations thereof, wherein the plurality of switches comprises transistors, gate commutated thyristors, field effect transistors, insulated gate bipolar transistors, gate turn-off thyristors, static induction transistors, static induction thyristors, or combinations thereof.

7. The power generation system of claim 1, wherein the control system further comprises one or more sensors coupled to the first power source, the second power source, and the controller, wherein the one or more sensors are configured to generate electrical signals indicative of output voltage levels of the first power source and the second power source.

8. The power generation system of claim 7, wherein the controller is configured to compare the output voltage levels of the first power source and the second power source to determine the one power source of the first power source and the second power source having the lower output voltage level.

9. The power generation system of claim 7, wherein the controller is configured to selectively connect the one power source of the first power source and the second power source to the inverter via the DC-DC boost converter if a difference between the output voltage levels of the first power source and the second power source is greater than a predefined tolerance value.

10. A control system for a power generation system comprising a first power source, a second power source, an inverter, and a DC-DC boost converter, the control system comprising:
a switching contactor coupled between the first power source, the second power source, the inverter, and the DC-DC boost converter; and
a controller operatively coupled to the switching contactor and configured to control switching of the switching contactor to:
selectively connect one power source of the first power source and the second power source having a lower output voltage level among the first power source and the second power source to the inverter via the DC-DC boost converter; and
selectively connect other power source of the first power source and the second power source directly to the inverter.

11. The power generation system of claim 10, wherein the switching contactor comprises a plurality of switches, wherein the plurality of switches comprises diodes, transistors, gate commutated thyristors, field effect transistors, insulated gate bipolar transistors, gate turn-off thyristors, static induction transistors, static induction thyristors, or combinations thereof.

12. The power generation system of claim 10, wherein the control system further comprises one or more sensors coupled to the first power source, the second power source, and the controller, wherein the one or more sensors are configured to generate electrical signals indicative of output voltage levels of the first power source and the second power source.

13. The power generation system of claim 12, wherein the controller is configured to compare the output voltage levels of the first power source and the second power source to determine the one power source of the first power source and the second power source having the lower output voltage level.

14. The power generation system of claim 12, wherein the controller is configured to selectively connect the one power source of the first power source and the second power source to the inverter via the DC-DC boost converter if a difference between the output voltage levels of the first power source and the second power source is greater than a predefined tolerance value.

15. A method for operating a power generation system comprising a first power source, a second power source, an inverter, and a DC-DC boost converter, the method comprising:
determining output voltage levels of the first power source and the second power source based on electrical signals received from one or more sensors coupled to the first power source and the second power source;
determining a power source of the first power source and the second power source having a lower output voltage level by comparing the output voltage levels of the first power source with the second power source; and
selectively connecting:
the power source having the lower output voltage level among the first power source and the second power source to the inverter via the DC-DC boost converter by controlling switching of a switching contactor, and
other power source of the first power source and the second power source directly to the inverter by controlling switching of the switching contactor.

16. The method of claim 15, wherein the output voltage levels are open-circuit voltage level corresponding to the first power source and the second power source.

17. The method of claim 15, wherein the output voltage levels are estimated output voltage levels under load corresponding to the first power source and the second power source.

18. The method of claim 15, further comprising determining a difference between the output voltage levels of the first power source and the second power source.

19. The method of claim 18, wherein the power source having the lower output voltage level among the first power source and the second power source is connected to the inverter via the DC-DC boost converter if the difference is greater than a predefined tolerance value.
